(19) United States
(12) Patent Application Publication
(10) Pub. No.: US 2011/0056276 A1
(43) Pub. Date: Mar. 10, 2011

(54) ANTI-FOULING SUBMERSIBLE LIQUID SENSOR AND METHOD

(75) Inventors: Elijah L Scott, Loveland, CO (US); Scott D. Janson, Loveland, CO (US)

(73) Assignee: Hach Company, Loveland, CO (US)

(21) Appl. No.: 12/556,108

(22) Filed: Sep. 9, 2009

(51) Int. Cl. G01N 1/44

(52) U.S. Cl. 73/64.56; 250/432 R

(57) ABSTRACT

An anti-fouling submersible liquid sensor (100) is provided according to the invention. The anti-fouling submersible liquid sensor (100) includes a measurement chamber (102) including one or more liquid measurement sensors (121) and at least one chamber aperture (104), at least one gate (107), a gate actuator (128) configured to selectively move the at least one gate (107) between open and closed positions with regard to the at least one chamber aperture (104), and a radiation source (124) configured to inactivate at least a portion of a liquid sample in the measurement chamber (102). The anti-fouling submersible liquid sensor (100) is configured to admit the liquid sample into the measurement chamber (102), perform one or more measurements on the liquid sample, substantially inactivate biological material within the liquid sample with radiation from the radiation source (124), and hold the inactivated liquid sample until a next sample time.

### BACKGROUND OF THE INVENTION

1. Field of the Invention

The invention is related to the field of liquid sensors, and more particularly, to submersible liquid sensors.

2. Description of the Prior Art

FIG. 1 shows a prior art submersible water sensor. The prior art submersible water sensor is configured to be substantially submerged in water and perform periodic measurements. The prior art submersible water sensor can store measurements over time. The prior art submersible water sensor can upload or transfer the gathered measurements to external devices. In this manner, the prior art submersible water sensor can measure and monitor one or more aspects of the water over long periods.

The measurements can include any desired measurements, such as characteristics of the water or foreign material in the water, for example. Characteristics of the water can include temperature, pH, etc. Foreign material can include natural phenomena such as salinity or can comprise pollutants or other materials. Such monitoring can include the monitoring of water to be used for human consumption or use, the monitoring of water to be used for irrigation or other agricultural uses, or monitoring for contamination, et cetera. In this manner, the condition of the water can be tracked over time and changes can be noted, recorded, and/or acted upon.

Many large bodies of water will include biological or living material, even when held in man-made structures. For example, the water may have algae and bacteria growing therein. Further, small non-plant life may proliferate. Such materials can interfere with operation of the prior art submersible sensor, especially optical measurements involving light transmission and/or reception. Biological growth in the water will impede or even block the operation of optical sensors. Biological growth may also foul other sensors and may even block passages or openings, interfering with movement of water within the prior art submersible sensor.

A prior art approach to biological fouling has been the use of a biocide, wherein the biocide is deployed within the prior art submersible water sensor to kill algae and other biological material. The prior art submersible water sensor therefore can include a container of biocide and can dispense a portion of biocide into a sensor chamber. Alternatively, the biocide can be in the form of plating or a layer formed on the prior art submersible sensor, such as a copper material, wherein the material leaches into or is consumed by the water (such as through corrosion) and poisons the living material therein.

The prior art approach has drawbacks. While biocide prevents fouling of the prior art sensor, addition of biocide to the water can present problems. An increasing number of jurisdictions regulate addition of such materials to water. Therefore, it is undesirable to add any chemical treatment to a water sample. Even a very small water sample. Further, biocidal layers can leach or emit material into the water or liquid and therefore is consumed and requires replacement.

Further, the need to replenish a biocide material in the prior art submersible water sensor presents difficulties of extra maintenance, replacing a cleaning operation with a refilling operation.

### ASPECTS OF THE INVENTION

In some aspects of the invention, an anti-fouling submersible liquid sensor comprises:
a measurement chamber including one or more liquid measurement sensors and at least one chamber aperture;
at least one gate;
a gate actuator configured to selectively move the at least one gate between open and closed positions with regard to the at least one chamber aperture; and
a radiation source configured to inactivate at least a portion of a liquid sample in the measurement chamber, wherein the submersible liquid sensor is configured to:
   admit the liquid sample into the measurement chamber;
   perform one or more measurements on the liquid sample;
   substantially inactivate biological material within the liquid sample with radiation from the radiation source; and
   hold the inactivated liquid sample until a next sample time.

Preferably, the inactivation substantially sterilizes the liquid sample.

Preferably, the inactivation is performed after the one or more measurements are performed.

Preferably, the inactivation is performed before, during, or after the one or more measurements are performed.

Preferably, the inactivation is periodically performed until the next sample time.

Preferably, the submersible liquid sensor further includes at least one circulator that circulates the liquid sample during at least a portion of the inactivation.

Preferably, the submersible liquid sensor further includes an inactivation chamber that receives at least a portion of the radiation source, with the inactivation chamber being in liquid communication with the measurement chamber.

Preferably, the at least one gate comprises at least two gates and the at least one chamber aperture comprises at least two chamber apertures, wherein liquid can flow through the measurement chamber when the at least two gates are at least partially open.

Preferably, the at least one gate comprises at least one sliding gate.

Preferably, the at least one gate comprises a substantially cylindrical rotatable shell and at least one shell aperture formed in the rotatable shell, with the at least one shell aperture corresponding to, and configured to be aligned with, the at least one chamber aperture when the rotatable shell is in a substantially open position.

In some aspects of the invention, an anti-fouling submersible liquid sensor comprises:

a substantially cylindrical body including a measurement chamber, with the measurement chamber including one or more liquid measurement sensors and at least one chamber aperture;
at least one gate, comprising:
   a substantially cylindrical rotatable shell; and
   at least one shell aperture formed in the rotatable shell, with the at least one shell aperture corresponding to, and configured to be aligned with, the at least one chamber aperture when the rotatable shell is in a substantially open position;
a gate actuator configured to selectively move the at least one gate between open and closed positions with regard to the at least one chamber aperture; and
a radiation source configured to inactivate at least a portion of a liquid sample in the measurement chamber, wherein the submersible liquid sensor is configured to:
   admit the liquid sample into the measurement chamber;
   perform one or more measurements on the liquid sample;
   substantially inactivate biological material within the liquid sample with radiation from the radiation source; and
   hold the inactivated liquid sample until a next sample time.

Preferably, the inactivation substantially sterilizes the liquid sample.

Preferably, the inactivation is performed after the one or more measurements are performed.

Preferably, the inactivation is performed before, during, or after the one or more measurements are performed.

Preferably, the inactivation is periodically performed until the next sample time.

Preferably, the submersible liquid sensor further includes at least one circulator that circulates the liquid sample during at least a portion of the inactivation.

Preferably, the submersible liquid sensor further includes an inactivation chamber that receives at least a portion of the radiation source, with the inactivation chamber being in liquid communication with the measurement chamber.

Preferably, the at least one gate comprises at least two gates and the at least one chamber aperture comprises at least two chamber apertures, wherein liquid can flow through the measurement chamber when the at least two gates are at least partially open.

In some aspects of the invention, an anti-fouling submersible liquid sensor operation method comprises:
admitting a liquid sample into a measurement chamber of an anti-fouling submersible liquid sensor;
performing one or more measurements on the liquid sample;
substantially inactivating the liquid sample with radiation; and
holding the inactivated liquid sample until a next sample time.

Preferably, the inactivation substantially sterilizes the liquid sample.

Preferably, the inactivation is performed after the one or more measurements are performed.

Preferably, the inactivation is performed before, during, or after the one or more measurements are performed.

Preferably, the inactivation is periodically performed until the next sample time.

Preferably, further including circulating the liquid sample during at least a portion of the inactivation.

### BRIEF DESCRIPTION OF THE DRAWINGS

The same reference number represents the same element on all drawings. It should be understood that the drawings are not necessarily to scale.

FIG. 1 shows a prior art water sensor.

FIG. 2 shows an anti-fouling submersible liquid sensor according to the invention.

FIG. 3 is a flowchart of an anti-fouling submersible liquid sensor operation method according to the invention.

FIG. 4 shows the anti-fouling submersible liquid sensor according to the invention.

FIG. 5 shows the anti-fouling submersible liquid sensor according to the invention.

FIG. 6 shows the anti-fouling submersible liquid sensor when a shell aperture(s) is substantially aligned with a chamber aperture(s).

FIG. 7 shows a combined circulator/radiation source according to the invention.

FIG. 8 shows the combined circulator/radiation source affixed to and part of a test chamber portion of the anti-fouling submersible liquid sensor according to the invention.

### DETAILED DESCRIPTION OF THE INVENTION

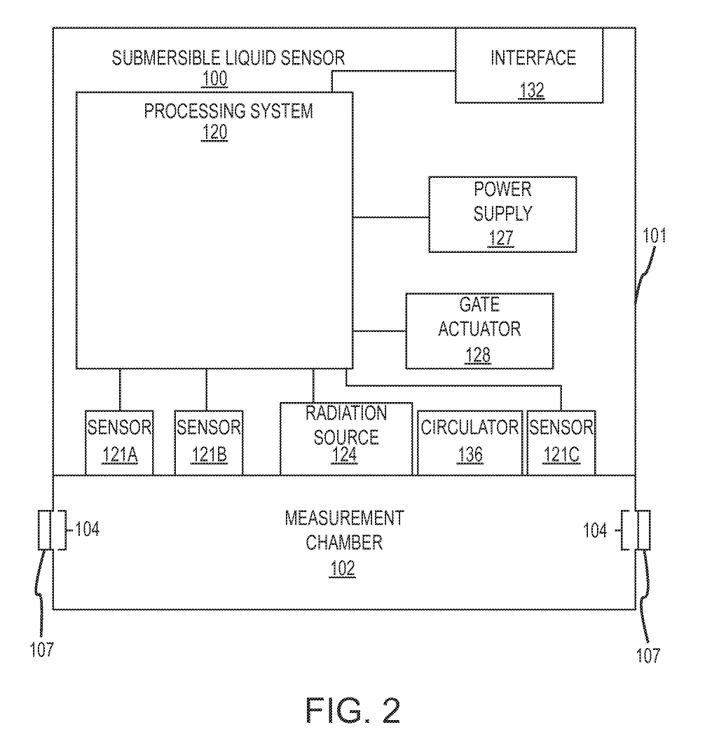

FIGS. 2-8 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 shows an anti-fouling submersible liquid sensor 100 according to the invention. The anti-fouling submersible liquid sensor 100 is designed to be submersed in a liquid and take measurements of the liquid, especially repeated measurements over time. The measurements can be accumulated by the anti-fouling submersible liquid sensor 100. The measurements can be relayed by the anti-fouling submersible liquid sensor 100 to other devices. The measurements can be stored and periodically relayed to other devices by the anti-fouling submersible liquid sensor 100.

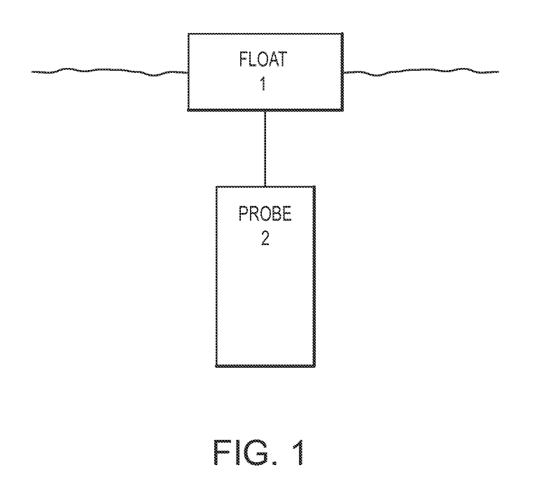

The anti-fouling submersible liquid sensor 100 can comprise a probe 2 portion as shown in FIG. 1, wherein the anti-fouling submersible liquid sensor 100 is suspended below a float 1. Alternatively, the anti-fouling submersible liquid sensor 100 can comprise a portion of the probe 2.

The anti-fouling submersible liquid sensor 100 is designed for long-term submerged use, but with the reduction or elimination of fouling. Fouling may refer to the growth of biological material, wherein sensors or instruments of the anti-fouling submersible liquid sensor 100 can be impeded or rendered unworkable by the biological material. The reduction or elimination of fouling within the anti-fouling submersible liquid sensor 100 has advantages. The reduction or elimination of fouling reduces or eliminates the need for routine maintenance, such as retrieval of the anti-fouling submersible liquid sensor 100 for cleaning and inspection.

The anti-fouling submersible liquid sensor 100 differs from the prior art by keeping sensors (and the entirety of a measurement chamber) free of biological growth. The anti-fouling submersible liquid sensor 100 differs from the prior art by inactivating biological material taken inside the anti-fouling submersible liquid sensor 100. The anti-fouling submersible liquid sensor 100 differs from the prior art by inactivating a liquid sample. The anti-fouling submersible liquid sensor 100 differs from the prior art by inactivating a liquid sample and then holding the liquid sample until the time when a new liquid sample is needed. In this manner, the exposure of sensors (and indeed the liquid sensor interior) to biological materials is kept to an absolute minimum, greatly reducing the risk of fouling of the anti-fouling submersible liquid sensor 100.

This results in a lower maintenance cost and lower maintenance time. This results in fewer interruptions in liquid sensor operation and provides a more accurate and trouble-free operation.

The inactivation may be performed after liquid measurements have been performed. The inactivation may be done after the measurements if the measurements require or allow living biological material in the liquid sample.

The inactivation may be performed periodically in order to prevent growth or re-growth of biological material. This may be desirable or necessary if the liquid sample is held for an extensive time. This may be desirable or necessary if the biological material is heavily concentrated in the liquid or is otherwise tenacious or pervasive.

The inactivation may be performed before some or all liquid measurements if the inactivation does not interfere with the measurements. For example, turbidity is a measurement of solid particles suspended in water, where a turbidity measurement typically involves measurement of light that is scattered by the suspended solids. The turbidity measurement is typically not affected by the living or non-living status of the solids. However, it is desired that biological materials to not continue to grow inside the anti-fouling submersible liquid sensor 100.

The anti-fouling submersible liquid sensor 100 comprises a body 101, a measurement chamber 102 formed in a portion of the body 101, at least one chamber aperture 104, and at least one gate 107 that is configured to block and unblock the chamber aperture 104. When the gate 107 is positioned at least partially away from the chamber aperture 104, then liquid can move into or out of the measurement chamber 102. When the gate 107 is positioned to fully block the chamber aperture 104, then liquid can be kept out of the measurement chamber 102 or held inside the measurement chamber 102.

The anti-fouling submersible liquid sensor 100 further comprises one or more sensors 121 and a radiation source 124 that are in communication with the measurement chamber 102. This may include projection at least partially into the measurement chamber 102. This may include use of a window, membrane, or other component that keeps liquid in the measurement chamber 102 but allows measurement of the liquid, or transmission of radiation into, the measurement chamber 102.

The anti-fouling submersible liquid sensor 100 further comprises a processing system 120, an interface 132, a power supply 127, a gate actuator 128, and a circulator 136 (or multiple circulators). The power supply 127 provides electrical power to the anti-fouling submersible liquid sensor 100, whether through the processing system 120, as shown, or directly to the components of the anti-fouling submersible liquid sensor 100. In some embodiments, the processing system 120 is in electrical communication with the sensors 121, the radiation source 124, the circulator 136, the gate actuator 128, and the interface 132.

The processing system 120 receives sensor signals generated by the sensors 121A-121C. The sensor signals can comprise measurements or may need processing in order to generate measurements from the sensor signals. It should be understood that any number of sensors 121 can be included. The processing system 120 can store the sensor signals. The processing system 120 can process the sensor signals. The processing system 120 can process the sensor signals using any manner of stored data, formula, algorithms, et cetera. The processing system 120 can relay or transmit the sensor signals (or processed sensor signals) to other devices, such as through the interface 132.

Further, the processing system 120 can initiate and/or control the generation of sensor signals. This can be achieved in some embodiments by the processing system 121 controlling the sensors 121A-121C. This can be achieved in some embodiments by the processing system 121 selectively providing electrical power to the sensors 121A-121C.

The processing system 120 controls the gate actuator 128, wherein the gate actuator 128 can actuate the at least one gate 107 to block or unblock the at least one chamber aperture 104.

If the anti-fouling submersible liquid sensor 100 includes multiple chamber apertures 104, it will include a corresponding number of multiple gates 107. Further, the gate actuator 128 will actuate the multiple gates 107.

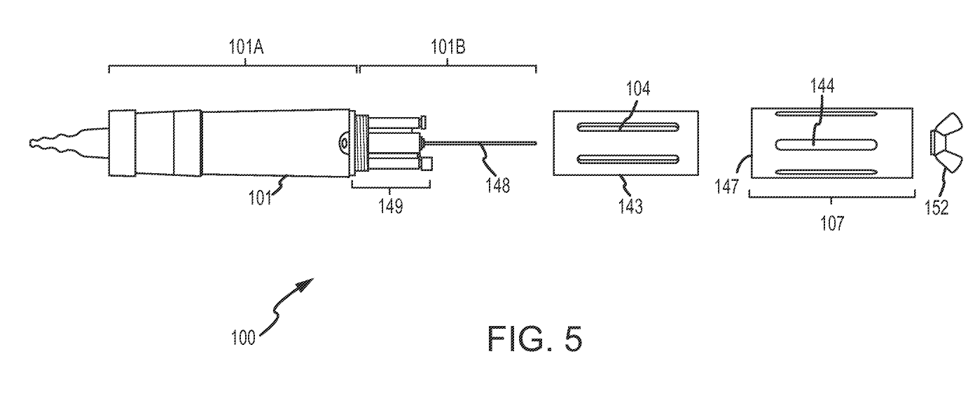

The at least one gate 107 can include multiple gates 107. The at least one gate 107 can actuate in any manner, including by moving or sliding, pivoting, rotating (see FIG. 5, for example, and the accompanying discussion), or any other manner of gate movement or operation.

The at least one gate 107 can include at least two gates 107. Two gates 107 will allow liquid flow through the measurement chamber 102 when the at least two gates are at least partially open.

The interface 132 comprises an interface between the anti-fouling submersible liquid sensor 100 and human operators and/or other devices. The interface 132 can include input devices that enable a human operator to interact with the anti-fouling submersible liquid sensor 100, such as for activating, configuring, or verifying the anti-fouling submersible liquid sensor 100. The interface 132 can include output devices for displaying data, measurements, sensor status, power level, or any other desired information. The interface 132 can include communications for communicating with other devices, including transmitting measurements and data, for example.

The circulator 136 is coupled to the processing system 120 and can be actuated to circulate liquid in the measurement chamber 102. The circulating can be done when the at least one gate 107 is blocking the at least one chamber aperture 104. The circulating can be done when the radiation source 124 is energized to inactivate the liquid sample. Further, the circulator 136 can be actuated to move liquid into and out of the measurement chamber 102. The movement of liquid into and out of the measurement chamber 102 can occur when the at least one gate 107 is not blocking (or at least not fully blocking) the at least one chamber aperture 104. The circulating fluid can be directed to dislodge biological material, such as material attached to sensors, for example. Further, the anti-fouling submersible liquid sensor 100 can include mechanical structures configured to dislodge or loosen biological material.

In operation, the anti-fouling submersible liquid sensor 100 is configured to admit a liquid sample into the measurement chamber 102, perform one or more measurements on the liquid sample, substantially inactivate biological material within the liquid sample with radiation from the radiation source 124, and hold the liquid sample until a next sample time. This process may be performed at predetermined time periods.

The anti-fouling submersible liquid sensor 100 can be used in various liquids. For water testing, the anti-fouling submersible liquid sensor 100 can be submerged in a body of water, including flowing and non-flowing bodies of water, above ground or below-ground, water in man-made enclosures or in natural bodies of water, et cetera. The anti-fouling submersible liquid sensor 100 can be partially or fully submerged.

The inactivation performed by the radiation source 124 comprises an inactivation of biological materials, such as algae, through destruction of cell walls. The inactivation can kill or inhibit growth of biological material, including plant life, animal life (such as barnacles, for example), or any type of microscopic biological material. The activation/sterilization can also comprise an effective viricide and bactericide. Depending on the level of biological materials in the liquid sample, the radiation source 124 can be controlled to emit radiation for a needed time period. The radiation can comprise any desired radiation, including visible and non-visible radiation. For example, the radiation source 124 can emit ultraviolet (UV) radiation. However, other types of radiation are contemplated and are within the scope of the description and claims.

The sensors 121A-121C can perform any manner of tests, including optical tests, electrical tests, electrochemical tests, or others. Many of these liquid tests will be impeded or rendered inaccurate by biological growth. For example, if a sensor is an optical sensor, high levels of biological growth will reduce or block light and interfere with optical measurements. The sensors 121A-121C in some embodiments can be removable, configurable, or otherwise replaceable.

It should be understood that the anti-fouling submersible liquid sensor 100 does not add any biocide matter or material to the water or liquid. The anti-fouling submersible liquid sensor 100 does not leach out, release, or emit any biocide or poison. The anti-fouling submersible liquid sensor 100 does not dispense or employ any consumable material(s) as a biocide.

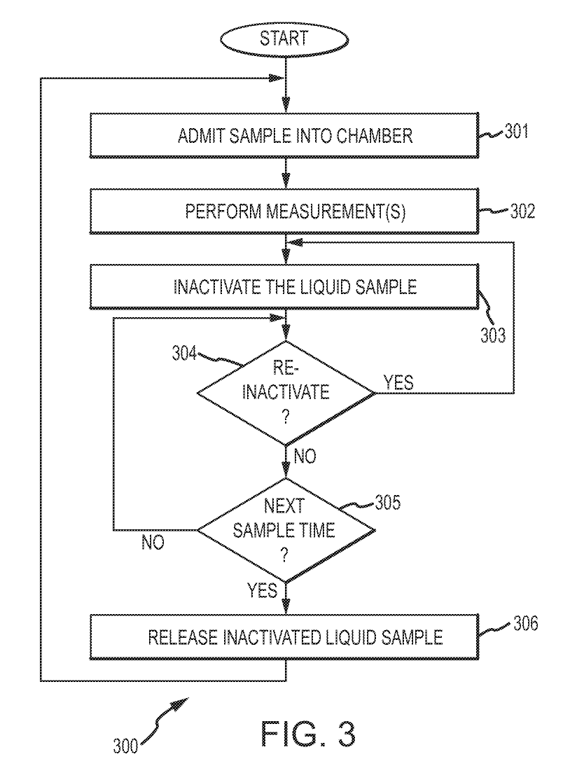

FIG. 3 is a flowchart 300 of an anti-fouling submersible liquid sensor operation method according to the invention. In step 301, a liquid sample is admitted into the submersible liquid sensor, such as into a measurement chamber. The admitting can include opening one or more gates and can include operating a circulator (i.e., a liquid-moving device) to bring in a liquid sample. The operation of bringing in a liquid sample may push or flush out a previous liquid contents.

In step 302, one or more measurements may be performed on the liquid sample. The one or more measurements can include any manner of liquid measurements/tests. The one or more measurements can therefore be performed on the liquid sample before the liquid sample is inactivated. However, it should be understood that in a submersible liquid sensor, some sample periods may not require measurement or testing, and the submersible liquid sensor may simply perform sample acquisition and inactivation. Further, some measurements may be performed after the inactivation process. Or both before and after the inactivation process, if desired.

In step 303, the liquid sample is inactivated. The inactivation includes exposing the liquid sample to radiation for a predetermined inactivation time period. The inactivation substantially kills biological material in the liquid sample. For example, the inactivation may kill algae in the liquid sample, wherein the algae will not grow and interfere with sensors of the submersible liquid sensor. The predetermined inactivation time period may be chosen according to the expected biological material in the liquid sample, according to the expected amount of biological material, and/or other factors.

In step 304, the process may optionally check a re-inactivation timer, wherein the liquid sample can be re-inactivated if held for a long period of time. This may depend on the expected algae type, concentration, or other factors. As a consequence, the liquid sample may be kept inactivated, even if the sampling time is very long. If it is time for a re-inactivation, the method may branch back to step 303 and re-perform the inactivation of the liquid sample. Otherwise, the method may proceed on to step 305.

In step 305, the process checks to see if it is time to acquire a new liquid sample. If it is not time, then the method can loop back and continue to wait. In some embodiments, the method loops back to step 304. By holding the inactivated liquid sample in the submersible liquid sensor, growth of biological material inside the submersible liquid sensor is prevented or greatly diminished.

If it is time to acquire a new liquid sample, then the method proceeds on to step 306.

In step 306, the inactivated liquid sample held within the submersible liquid sensor is released. The release is in preparation for acquiring a new liquid sample. The method then loops back to step 301 and the process is iteratively performed. In this manner, liquid samples can be periodically and repeatedly obtained and measured, but while eliminating or greatly reducing the biological growth within the submersible liquid sensor.

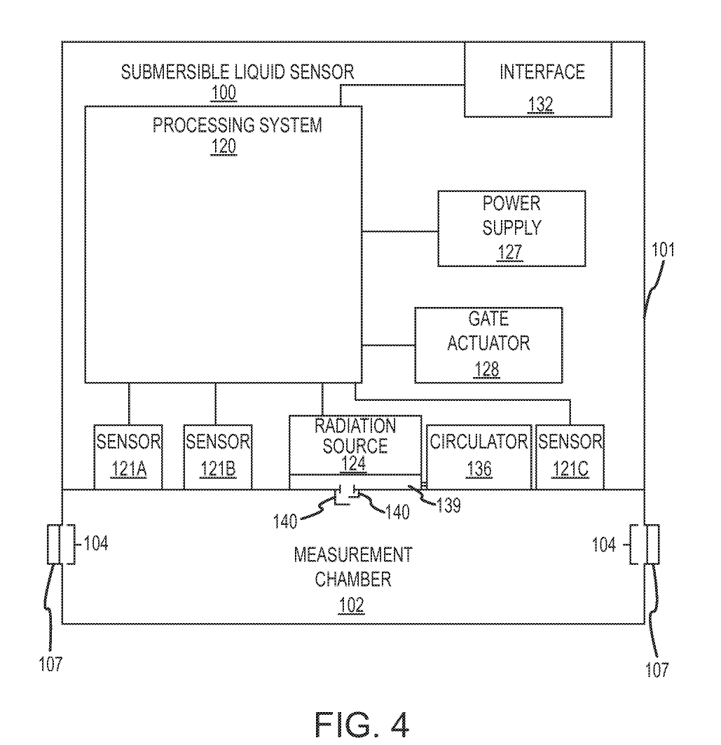

FIG. 4 shows the anti-fouling submersible liquid sensor 100 according to the invention. In this embodiment, the anti-fouling submersible liquid sensor 100 includes an inactivation chamber 139 that is in liquid communication with the measurement chamber 102. In the inactivation operation, the radiation source 124 transmits radiation into the inactivation chamber 139. Therefore, in this embodiment, the inactivation occurs in the inactivation chamber 139.

The inactivation chamber 139 may prevent or minimize transmission of radiation to the sensors 121. Further, the inactivation chamber 139 may include a baffle or baffles 140 that substantially contain the radiation within the inactivation chamber 139.

Liquid in the measurement chamber 102 may be at least partially circulated through the inactivation chamber 139. In some embodiments, the circulator 136 may be in fluidic communication with the inactivation chamber 139. Consequently, the circulator 136 may move liquid through the inactivation chamber 139.

FIG. 5 shows the anti-fouling submersible liquid sensor 100 according to the invention. In this embodiment, the anti-fouling submersible liquid sensor 100 includes a substantially cylindrical body 101 including a test chamber portion 101B and an electronics portion 101A. The test chamber portion 101B can include a sensor package 149 including any manner of sensors 121, the radiation source 124, the circulator 128, and/or the gate actuator 128, et cetera. The test chamber portion 101B in this embodiment further includes an inner sleeve 143 including the at least one chamber aperture 104. The inner sleeve 143 is affixed to the body 101. The inner sleeve 143 may be removably affixed to the body 101. The at least one chamber aperture 104 can be in the form of slots, as shown. However, it should be understood that the one or more chamber apertures 104 are contemplated to be of any shape and size.

The anti-fouling submersible liquid sensor 100 in this embodiment further includes a substantially cylindrical rotatable shell 147 including at least one shell aperture 144. The at least one shell aperture 144 corresponds to, and can be aligned with, the at least one chamber aperture 104. The rotatable shell 147 and the inner sleeve 143 can include multiple corresponding apertures. The rotatable shell 147 fits over the inner sleeve 143. The rotatable shell 147 is configured to rotate with respect to the inner sleeve 143. The rotatable shell 147 is configured to be rotatably held to the body 101. In one embodiment, an elongate member 148 and a fastener 152 cooperate to removably hold the rotatable shell 147 to the body 101. The fastener 152 can comprise a threaded fastener or alternatively can comprise any other manner of fixed or removable fastener.

The gate actuator 128 rotates the rotatable shell 147. The rotation can align the at least one shell aperture 144 of the rotatable shell 147 with the at least one chamber aperture 104 of the inner sleeve 143 in order to open the measurement chamber 102. The rotation can offset the at least one shell aperture 144 from the at least one chamber aperture 104 in order to close the measurement chamber 102.

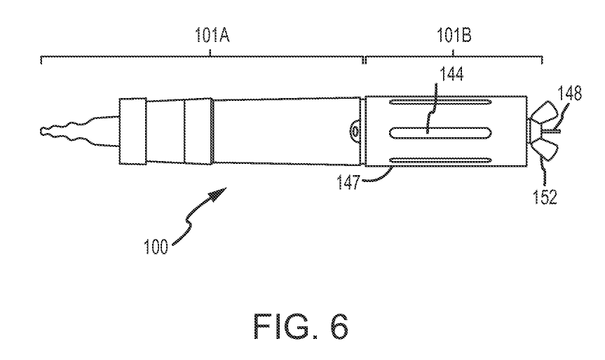

FIG. 6 shows the anti-fouling submersible liquid sensor 100 when the shell aperture(s) 144 is substantially aligned with the chamber aperture(s) 104. In this position of the rotatable shell 147, liquid can flow into the measurement chamber 102, can flow out of the measurement chamber 102, or can flow through the measurement chamber 102.

As can be seen from this figure, rotation of the rotatable shell 147 from the shown position will serve to block the aperture(s) and close off the measurement chamber 102.

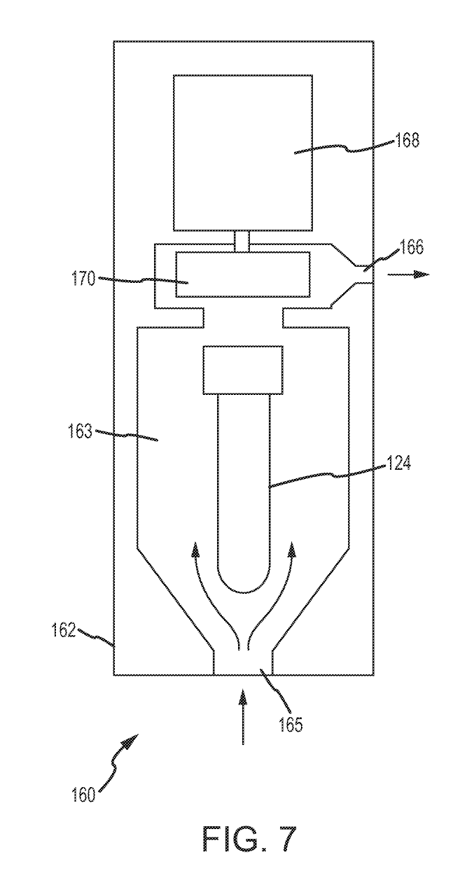

FIG. 7 shows a combined circulator/radiation source 160 according to the invention. The combined circulator/radiation source 160 includes a body 162, a flow chamber 163, an inlet 165, an outlet 166, the radiation source 124 in the flow chamber 163, a motor 168, and an impeller 170. The radiation source 124 can be energized to emit radiation into the flow chamber 163. The motor 168 can be energized to rotate the impeller 170 and move liquid through the flow chamber 163, as shown by the arrows. The liquid flow can be achieved to move liquid past the radiation source 124, including during liquid inactivation. The liquid flow can be achieved to circulate liquid in the measurement chamber 102, including during liquid measurements. Therefore, the motor 168 and the radiation source 124 can be energized together or independently.

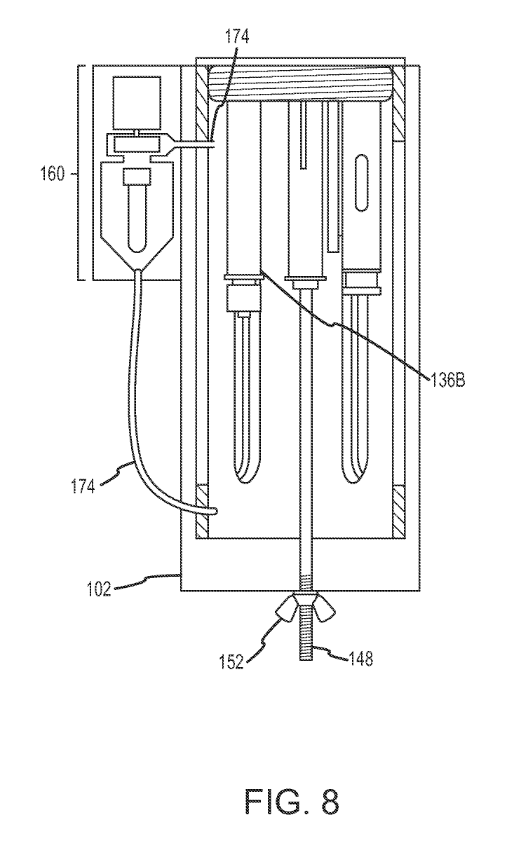

FIG. 8 shows the combined circulator/radiation source 160 affixed to and part of the test chamber portion 101B of the anti-fouling submersible liquid sensor 100 according to the invention. Conduits 174 place the combined circulator/radiation source 160 in liquid communication with the measurement chamber 102. Alternatively, the combined circulator/radiation source 160 can be located within the measurement chamber 102. The figure also shows an additional circulator 136B located within the measurement chamber 102 in some embodiments.

We claim:

1. An anti-fouling submersible liquid sensor (100), comprising:
a measurement chamber (102) including one or more liquid measurement sensors (121) and at least one chamber aperture (104);
at least one gate (107);
a gate actuator (128) configured to selectively move the at least one gate (107) between open and closed positions with regard to the at least one chamber aperture (104); and
a radiation source (124) configured to inactivate at least a portion of a liquid sample in the measurement chamber (102), wherein the anti-fouling submersible liquid sensor (100) is configured to:
admit the liquid sample into the measurement chamber (102);
perform one or more measurements on the liquid sample;
substantially inactivate biological material within the liquid sample with radiation from the radiation source (124); and
hold the inactivated liquid sample until a next sample time.

2. The anti-fouling submersible liquid sensor (100) of claim 1, wherein the inactivation substantially sterilizes the liquid sample.

3. The anti-fouling submersible liquid sensor (100) of claim 1, wherein the inactivation is performed after the one or more measurements are performed.

4. The anti-fouling submersible liquid sensor (100) of claim 1, wherein the inactivation is performed before, during, or after the one or more measurements are performed.

5. The anti-fouling submersible liquid sensor (100) of claim 1, wherein the inactivation is periodically performed until the next sample time.

6. The anti-fouling submersible liquid sensor (100) of claim 1, with the anti-fouling submersible liquid sensor (100) further including at least one circulator (136) that circulates the liquid sample during at least a portion of the inactivation.

7. The anti-fouling submersible liquid sensor (100) of claim 1, with the anti-fouling submersible liquid sensor (100) further including an inactivation chamber (139) that receives at least a portion of the radiation source (124), with the inactivation chamber (139) being in liquid communication with the measurement chamber (102).

8. The anti-fouling submersible liquid sensor (100) of claim 1, with the at least one gate (107) comprising at least two gates (107) and with the at least one chamber aperture (104) comprising at least two chamber apertures (104), wherein liquid can flow through the measurement chamber (102) when the at least two gates (107) are at least partially open.

9. The anti-fouling submersible liquid sensor (100) of claim 1, with the at least one gate (107) comprising at least one sliding gate (107).

10. The anti-fouling submersible liquid sensor (100) of claim 1, with the at least one gate (107) comprising:
a substantially cylindrical rotatable shell (147); and
at least one shell aperture (144) formed in the rotatable shell (147), with the at least one shell aperture (144) corresponding to, and configured to be aligned with, the at least one chamber aperture (104) when the rotatable shell (147) is in a substantially open position.

11. An anti-fouling submersible liquid sensor (100), comprising:
a substantially cylindrical body (101) including a measurement chamber (102), with the measurement chamber (102) including one or more liquid measurement sensors (121) and at least one chamber aperture (104);
at least one gate (107), comprising:
a substantially cylindrical rotatable shell (147); and
at least one shell aperture (144) formed in the rotatable shell (147), with the at least one shell aperture (144) corresponding to, and configured to be aligned with, the at least one chamber aperture (104) when the rotatable shell (147) is in a substantially open position;
a gate actuator (128) configured to selectively move the at least one gate (107) between open and closed positions with regard to the at least one chamber aperture (104); and
a radiation source (124) configured to inactivate at least a portion of a liquid sample in the measurement chamber (102), wherein the anti-fouling submersible liquid sensor (100) is configured to:
admit the liquid sample into the measurement chamber (102);
perform one or more measurements on the liquid sample;
substantially inactivate biological material within the liquid sample with radiation from the radiation source (124); and
hold the inactivated liquid sample until a next sample time.

12. The anti-fouling submersible liquid sensor (100) of claim 11, wherein the inactivation substantially sterilizes the liquid sample.

13. The anti-fouling submersible liquid sensor (100) of claim 11, wherein the inactivation is performed after the one or more measurements are performed.

14. The anti-fouling submersible liquid sensor (100) of claim 11, wherein the inactivation is performed before, during, or after the one or more measurements are performed.

15. The anti-fouling submersible liquid sensor (100) of claim 11, wherein the inactivation is periodically performed until the next sample time.

16. The anti-fouling submersible liquid sensor (100) of claim 11, with the anti-fouling submersible liquid sensor (100) further including at least one circulator (136) that circulates the liquid sample during at least a portion of the inactivation.

17. The anti-fouling submersible liquid sensor (100) of claim 11, with the anti-fouling submersible liquid sensor (100) further including an inactivation chamber (139) that receives at least a portion of the radiation source (124), with the inactivation chamber (139) being in liquid communication with the measurement chamber (102).

18. The anti-fouling submersible liquid sensor (100) of claim 11, with the at least one gate (107) comprising at least two gates (107) and with the at least one chamber aperture (104) comprising at least two chamber apertures (104), wherein liquid can flow through the measurement chamber (102) when the at least two gates (107) are at least partially open.

19. An anti-fouling submersible liquid sensor operation method, comprising:
admitting a liquid sample into a measurement chamber of an anti-fouling submersible liquid sensor;
performing one or more measurements on the liquid sample;
substantially inactivating the liquid sample with radiation; and
holding the inactivated liquid sample until a next sample time.

20. The method of claim 19, wherein the inactivation substantially sterilizes the liquid sample.

21. The method of claim 19, wherein the inactivation is performed after the one or more measurements are performed.

22. The method of claim 19, wherein the inactivation is performed before, during, or after the one or more measurements are performed.

23. The method of claim 19, wherein the inactivation is periodically performed until the next sample time.

24. The method of claim 19, further including circulating the liquid sample during at least a portion of the inactivation.
